(19) United States
(12) Patent Application Publication
(10) Pub. No.: US 2009/0159665 A1
(43) Pub. Date: Jun. 25, 2009

(54) Reserve currency card

(75) Inventor: Richard W. Vidrine, Key Largo, FL (US)

Correspondence Address: Richard Schuman, 603 Monroe Avenue, Cape Canaveral, FL, 33920, US

(73) Assignee: Fidelity Reserve Company

(21) Appl. No.: 12/287,140

(22) Filed: Oct. 7, 2008

Related U.S. Application Data
(60) Provisional application No. 61/016,520, filed on Dec. 24, 2007.

(51) Int. Cl. G06K 5/00

(52) U.S. Cl. 235/380

(57) ABSTRACT

The Reserve Currency Card is a standard sized gift card type of instrument that is sold at the retail level to anybody wishing to have or give a gift of a money market savings or investment account with a designated major fiduciary. The purchaser would be able to buy the card in various denominations, such as $25, 50, 75, 100, or 200 dollars, earmark the funds for a selected account type (depending on the amount), and reserve that selected amount for allocation to a specific investment account, subject to the terms and rules of the fiduciary. The purchaser may then establish an investment account with the designated fiduciary or, alternatively, give the card as a gift for another person to establish the account in the recipient's name. The account holder may purchase additional cards as often as desired to add funds to the account.

### BACKGROUND OF THE INVENTION

This invention pertains to the area of investing in stocks, bonds, money market accounts, mutual funds, and other financial instruments. A related Provisional Application was filed on Dec. 24, 2007, No. 61/016,520, Atty Docket No. RV758162.

Whereas the average consumer is often not educated in the process required to invest in the aforementioned financial instruments, and whereas the consumer often harbors the opinion that one needs considerable wealth to invest, and whereas the consumer is often of the opinion that there is not sufficient time to find a suitable investment, such as a mutual fund heavily invested in environmentally friendly stocks, and whereas the consumer often feels that he/she cannot afford to set aside a specific amount for investing each and every payday or month, this invention answers to all of these problems and more.

### BRIEF SUMMARY OF THE INVENTION

The object of the invention, the Reserve Currency Card, is to make investing as easy, affordable, and readily available to the average consumer, as it is to purchase a soft drink from a convenience store.

Authorized sellers will make the Reserve Currency Card available to consumers who may select and purchase a card of which the funds will be reserved for allocation to a specific investment or for an investment vehicle to be identified later, and select and purchase the card from a preset dollar value range, such as any amount between 25 and 200 dollars. The purchaser may then use the card to establish an account online or by phone, or give the card as a gift to another person who may do the same. Account holders may purchase additional cards at any time and add the amounts from the additional cards to their respective accounts. Buying and selling within the account will be subject to the rules established by the financial institution through which it is maintained.

### BRIEF DESCRIPTION OF THE SEVERAL VIEWS OF THE DRAWING

FIG. 1: A detailed front and back view of the Reserve Currency Card displaying the location of the licensee logo, barcode, PIN number, terms, amount (if it's a set amount), and type of financial instrument to which the funds will be reserved against, if designated.

FIG. 2: The process, depicted in standard flow chart symbols, of completing a Reserve Currency Card purchase and activation in an outlet authorized to sell the cards.

FIG. 3: The process, depicted in standard flow chart symbols, of using the Reserve Currency Card to establish an online account with the financial institution licensed to manage said accounts.

FIG. 4: The process, depicted in standard flow chart symbols, of using the Reserve Currency Card to establish an account, over the phone, with the financial institution licensed to manage said accounts.

FIG. 5: The process, depicted in standard flow chart symbols, of using an additional Reserve Currency Card to add funds to an existing account, online.

FIG. 6: The process, depicted in standard flow chart symbols, of using an additional Reserve Currency Card to add funds to an existing account, over the phone.

FIG. 7: The process, depicted in standard flow chart symbols, of using an additional Reserve Currency Card to add funds to an existing account, using the U.S. mail system.

### DETAILED DESCRIPTION OF THE INVENTION

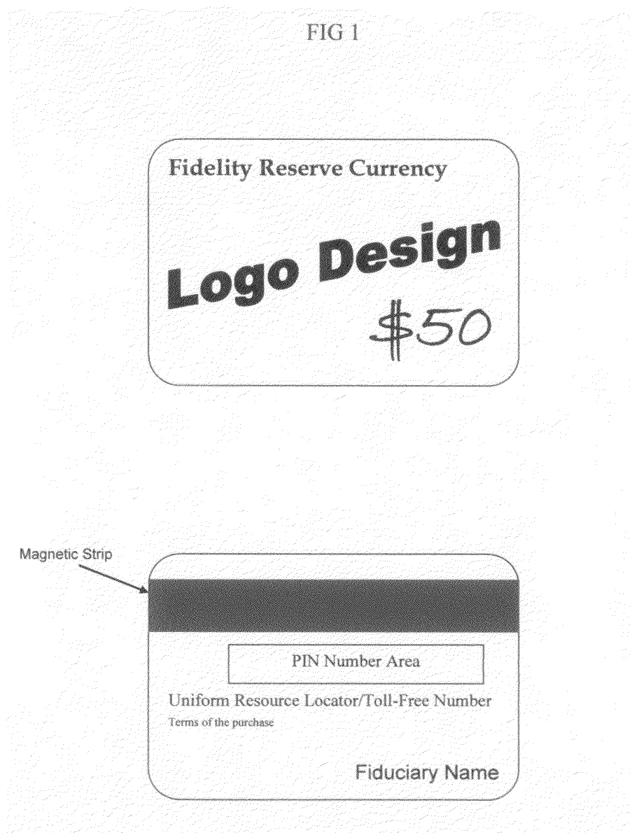

The Reserve Currency Card would be a standard sized gift card type of instrument, and sold at the retail level to anybody wishing to have or give a gift of a money market savings or investment account with a designated major fiduciary. The Reserve Currency Card would display, as a minimum, the name of the fiduciary, provide a PIN number (under a scratch-off material to protect the number until purchased), amount of the card (if it's a set amount), terms of the purchase, a Uniform Resource Locator for website access, a toll-free phone number of the fiduciary, a magnetic strip to manage price and serial number information, and a logo and description identifying the specified investment, if any. FIG. 1 displays a drawing of the front and back of a Reserve Currency Card.

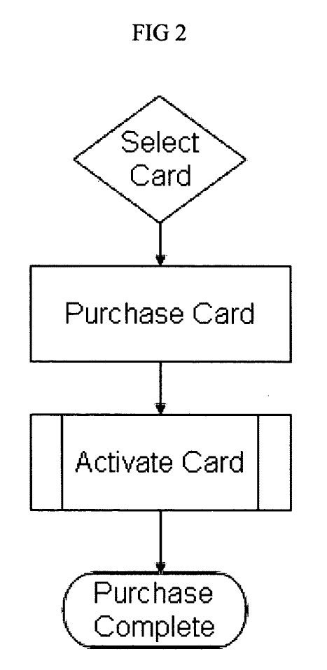

The purchaser would be able to buy the card in various denominations from $25 to 200 dollars, pay for the purchase at the retail vendor, and have the money immediately transferred through VISA, MasterCard, or other electronic conveyance system to the pre-designated major financial fiduciary, such as but not limited to a bank, insurance company, or mutual fund group. Upon legitimate purchase, the card would be swiped through a standard card reader at the retailer to send the card serial number and amount to a central card clearinghouse to be activated for immediate use by the purchaser. Card activation means transmitting the card serial number and dollar amount to the fiduciary. Depending on prior arrangements, any and all, applicable taxes, fees and service charges could be added on at the retail level and/or deducted from the face value of the card. The card purchase and activation process is displayed, using standard flowcharting symbols, in FIG. 2.

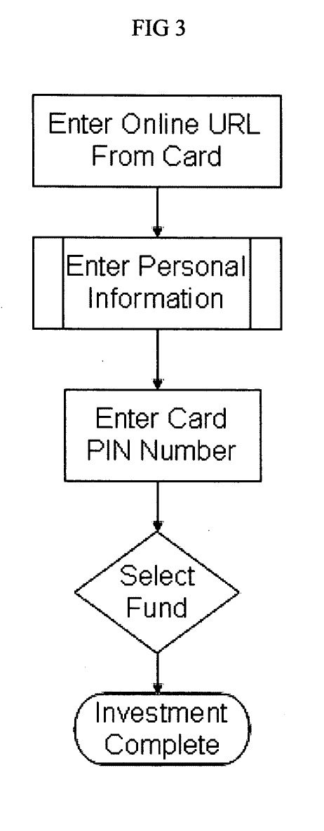

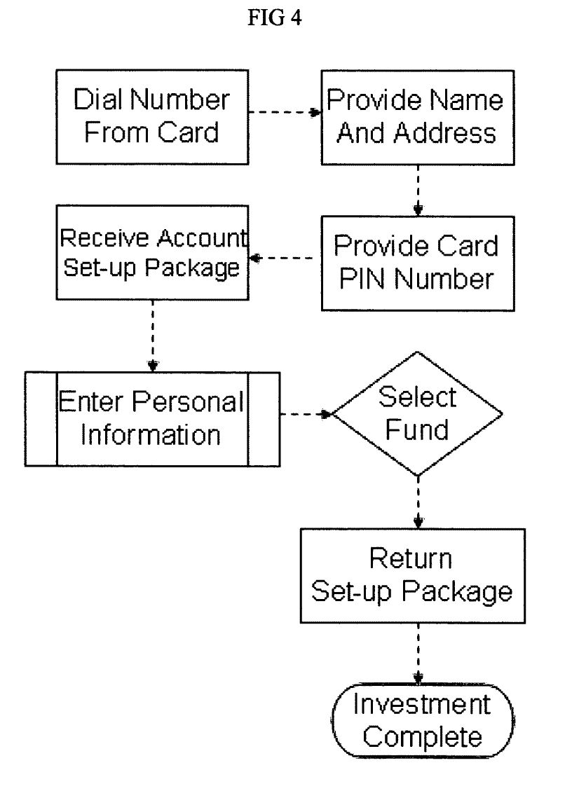

The funds reserved by the card would be allocated by establishing an investment account through the designated fiduciary. The card could be retained by the initial purchaser or given as a gift to any third party for any occasion. Upon receipt of the card by its ultimate owner, the owner would contact the fiduciary via phone or computer to set up the account. The fiduciary verifies the legitimacy of the card by matching the activated card serial number to its unique PIN number provided by the owner, and assuming they match, activates the new account with a unique alpha-numeric account number. Establishing the account requires personal information to be provided, such as account holder name, address, telephone number, social security number, along with online access information such as passwords or PIN numbers to enable quick and easy account access in the future. The account registration and activation process is displayed, using standard flowcharting symbols, in FIG. 3 and alternatively, in FIG. 4 if the account registration is initiated through the toll free number listed on the card. The toll free process will require the caller to provide personal information over the phone, along with the card PIN number to verify card legitimacy and establish a pending account. The card owner will then receive account registration information through the mail which must be completed and returned to the fiduciary to fully activate the account. The account holder will then be afforded the opportunity to establish a unique account PIN number to access account features of the phone.

Based on the initial amount allocated to the account and the rules of the fiduciary, all monies would be kept in an insured, interest bearing money market account until repeat purchases aggregate to a preset amount in the money market account. Once the preset amount is attained, the account holder would be given various options as to the vehicle—fund or depository—they wish to allocate the reserve. These cash reserve purchases could be made at any participating retailer and paid for by cash, check, credit, or debit card. If the preset amount is reached in the purchase of one card, the account holder will be given immediate access to the various fund or depository options. If the card purchase was for a specified vehicle, the funds would automatically transfer to that vehicle once the preset amount is reached.

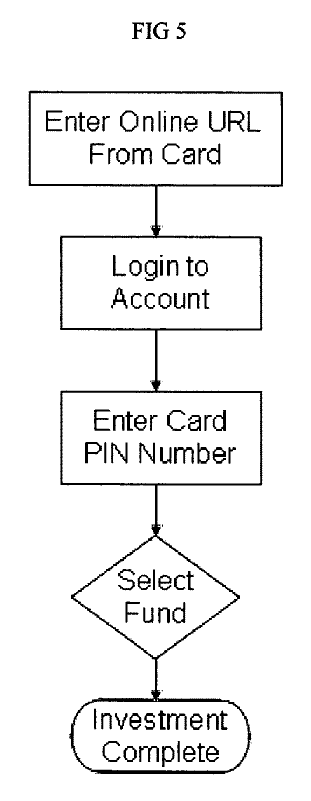

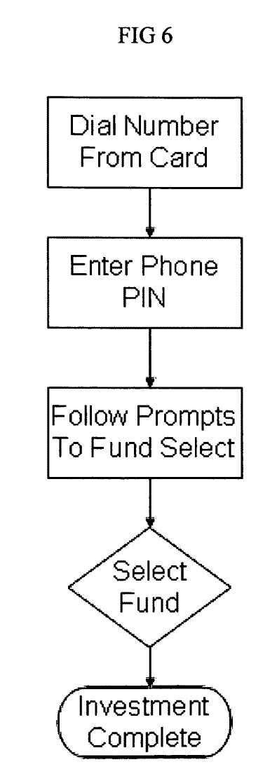

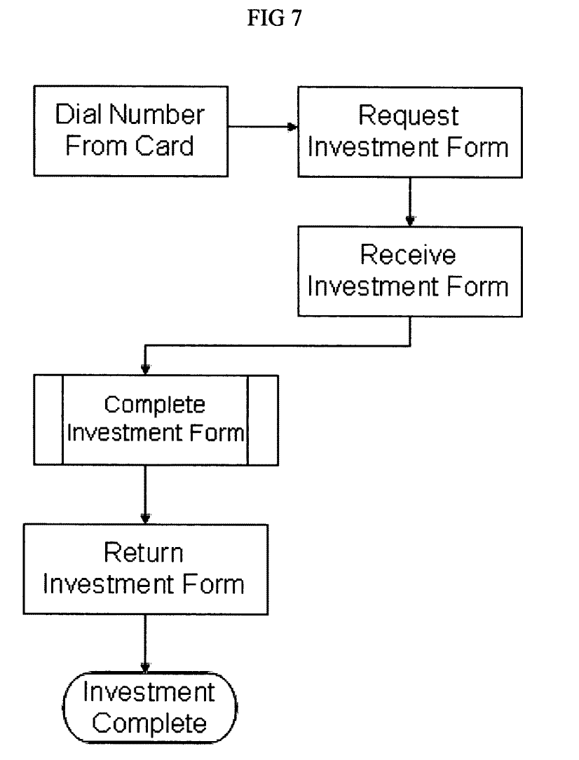

Once an account is registered and activated through the initial Reserve Currency Card, the owner may purchase additional cards, at any participating location, in any amount, at any time, and have them credited to his/her current account balance simply by providing the proper information, such as account and card PIN numbers, via computer or phone. FIG. 5 displays the online process, using standard flowcharting symbols, to allocate funds from additional cards to an active account. The online process requires four simple steps: access the fiduciary website, account login, card verification, and fund selection. FIG. 6 displays the telephone process, using standard flowcharting symbols, to allocate funds from additional cards to an active account. The telephone process requires four simple steps: dial the toll free number, account access with PIN, card verification, and fund selection. Some people will not wish to use automated services and will prefer written documents to maintain their account. FIG. 7 displays the mail process, using standard flowcharting symbols, to allocate funds from additional cards to an active account. The mail process requires one to request the proper forms through the toll free number, complete and return the forms to update the account. The mail process is a delayed form of adding funds to the account as compared to the online and toll free processes.

Subject to rules, regulations, and prior arrangements with the fiduciary, the account holder could withdraw any part or all of his/her reserve account and have it electronically transferred to a designated personal account. The fiduciary may also elect to provide several other services to the account holder that are independent of those intended by the Reserve Currency Card.

1. The Reserve Currency Card provides a simple process whereby a person may allocate funds for investment into stocks, bonds, a money market account, mutual funds, or other financial instruments by purchasing the card, within a specific dollar value range, in an outlet authorized to sell the cards.

2. The Reserve Currency Card provides a simple process whereby a person may routinely allocate additional funds for investment in different or the same stocks, bonds, money market account, mutual funds, or other financial instruments previously invested in, by purchasing additional cards, within a specified dollar value range, in an outlet authorized to sell the cards.

3. The Reserve Currency Card provides a simple process whereby a person may allocate funds for investment into stocks, bonds, a money market account, mutual funds, or other financial instruments, as a gift for another person, by purchasing the card, within a specific dollar value range, in an outlet authorized to sell the cards.

4. The Reserve Currency Card provides a simple process whereby a person may allocate funds for investment into a specified financial instrument by purchasing the card, within a specific dollar value range, in an outlet authorized to sell the cards.

5. The Reserve Currency Card provides a simple process whereby a person may receive one or multiple gifts of funds allocated for investment into stocks, bonds, a money market account, mutual funds, or other financial instruments incident to one or multiple purchasers giving the card to the designated recipient.

6. The Reserve Currency Card provides a simple process whereby a person may receive one or multiple gifts of funds allocated for investment in a specified financial instrument.
